(19) United States
(12) Patent Application Publication
(10) Pub. No.: US 2007/0158975 A1
(43) Pub. Date: Jul. 12, 2007

(54) Storage enclosure for small vehicles

(76) Inventors: G. William Atchison, Costa Mesa, CA (US); Edward L. Quinn, Dana Point, CA (US)

Correspondence Address: Edward E. Roberts, P.O. Box 3206, Dana Point, CA, 92629, US

(21) Appl. No.: 11/638,131

(22) Filed: Dec. 13, 2006

Related U.S. Application Data
(60) Provisional application No. 60/749,876, filed on Dec. 14, 2005.

(51) Int. Cl. B60R 9/00

(52) U.S. Cl. 296/182.1; 296/37.6

(57) ABSTRACT

A portable protective enclosure for motorcycles or other small vehicles comprising a planar base, right and left substantially identical rear roof members mating to encompass and enclose the rear area of the base, and a cab-like front portion for coverage of the front area of the base. The base includes a retractable ramp for insertion of the vehicle, rails and associated fasteners for fixedly mounting vehicles within the enclosure, right and left substantially identical utility compartments that are enclosed by the cab, a caster mechanism for mobility, and electrical means for providing such capabilities as interior lighting and exhaust and vehicle battery charging. Solar power means may also be included. Mutually engaging attachment devices are included for releasably joining the base, rear roof and cab members into an integrated assembled structure.

### CLAIM FOR BENEFIT OF EARLIER FILING DATE

The present utility application claims the benefit of U.S. Provisional Application No. 60/749,876 filed on 14 Dec. 2005 and entitled “Storage Enclosure for Small Vehicles”. The present utility application has the same inventors, subject matter and title as the aforesaid Provisional Application.

### BACKGROUND

The background of the invention will be discussed in two parts.

1. Field of the Invention

The invention relates generally to storage enclosures for small vehicles and more particularly to a protective storage enclosure for motorcycles that includes solar panels, interior electronics and lighting, and battery charging capabilities.

2. Prior Art

Motorcycles and other small personal vehicles are often exposed to harmful storage conditions and/or to risky security conditions, including weather and theft, encountered when the vehicle is parked without adequate protection such as in a secured garage. The problem is commonly recognized and examples of various apparatus and storage cases are disclosed in the prior art to protect small personal vehicles from such conditions. One such apparatus is shown and described in U.S. Pat. No. 6,012,253 issued to Burns on 11 Jan. 2000, the apparatus being a portable enclosure for small vehicles. Another such apparatus is shown and described in U.S. Pat. No. 6,742,674 issued to Melder on 24 Apr. 1956, the apparatus being a vehicle housing which conforms approximately to the size and shape of the vehicle. An ornamental design of a motorcycle storage case is shown in U.S. Pat. No. D492,243 issued to Greene on 29 Jun. 2004.

With knowledge of the short comings and deficiencies in the above disclosures, as well as in other known prior art, it is a primary aspect of the present invention to provide a new and improved storage enclosure for small vehicles and motorcycles, and more particularly to such enclosures which are compact, of simple construction, and readily assembled and disassembled. Another aspect of the invention is to provide an enclosure that is light in weight and can be inexpensively produced and which enables the vehicle to be easily and quickly placed into and removed from the interior thereof. Another aspect of the invention is to provide a sturdy easily movable motorcycle enclosure that includes electrical means for providing capabilities such as lighting, interior exhaust and battery charging. Other aspects, features and advantages of the invention will become apparent from a reading of the specification, and when taken in conjunction with the drawings wherein like reference numerals represent like elements in the several views serves to explain the principal invention in general terms.

### SUMMARY

The present invention relates to a sturdy protective storage enclosure primarily for motorcycles but that can be adapted for use with other small personal vehicles such as all-terrain vehicles, personal watercraft, and snow mobiles. The enclosure can be kept in a garage where it can be easily moved around by casters or the like, or if placed outside and properly anchored it provides protection of the vehicle from theft, the elements, or other detrimental conditions. The enclosure has a generally clam shell like configuration and comprises a planar base, right and left substantially identical rear roof portions mating to encompass and enclose the rear area of the base, and a cab-like front portion for coverage of the front area of the base. The base includes a retractable ramp for insertion of the vehicle, rails and associated fasteners for fixedly mounting vehicles within the enclosure, right and left substantially identical utility compartments that are enclosed by the cab, a caster mechanism for mobility, and electrical means for providing such capabilities as interior lighting and exhaust and vehicle battery charging. The cab includes outside covers for accessing the utility compartments. In addition to normal commercial power the enclosure may be fitted with solar power means. Attachment devices are included for engagement and release of the base, rear roof portions and cab members so as to provide an integrated assembled structure.

### DRAWINGS

FIG. 1 is a perspective view of an assembled enclosure embodying the invention illustrating the enclosure in the closed position;

FIG. 2 is a perspective view of the assembled enclosure of FIG. 1 illustrating substantially identical doors in the open position for accessing utility compartments, one on each side of the enclosure;

FIG. 3 is a perspective view of the assembled enclosure of FIG. 1 illustrating the right rear roofing member and the substantially identical left rear roofing member in the open position to thereby illustrate the interior of the enclosure;

FIG. 4 is a perspective view of the enclosure of FIG. 1 with the right and left rear roofing member removed to illustrate placement of a motorcycle within the enclosure of the invention;

FIG. 5 is a perspective view of the enclosure of FIG. 1 with the right and left rear roofing member removed to illustrate placement of two motorcycles within the enclosure of the invention;

FIG. 6 is a cut-away perspective view of the enclosure of FIG. 1 illustrating in greater detail the compartment for the mobility control mechanism of the invention;

FIG. 7 is a cross-sectional view taken generally along line 7-7 of FIG. 6 illustrating the mobility control mechanism of the invention with dual pads in the raised or retractable position whereby the associated caster is free to provide mobility of the enclosure;

FIG. 8 illustrates the mobility control mechanism of FIG. 7 with the dual pads in the lowered or caster raised position for stable stationary positioning of the enclosure; and

FIG. 9 is a perspective exploded view of the enclosure of the invention.

### DESCRIPTION

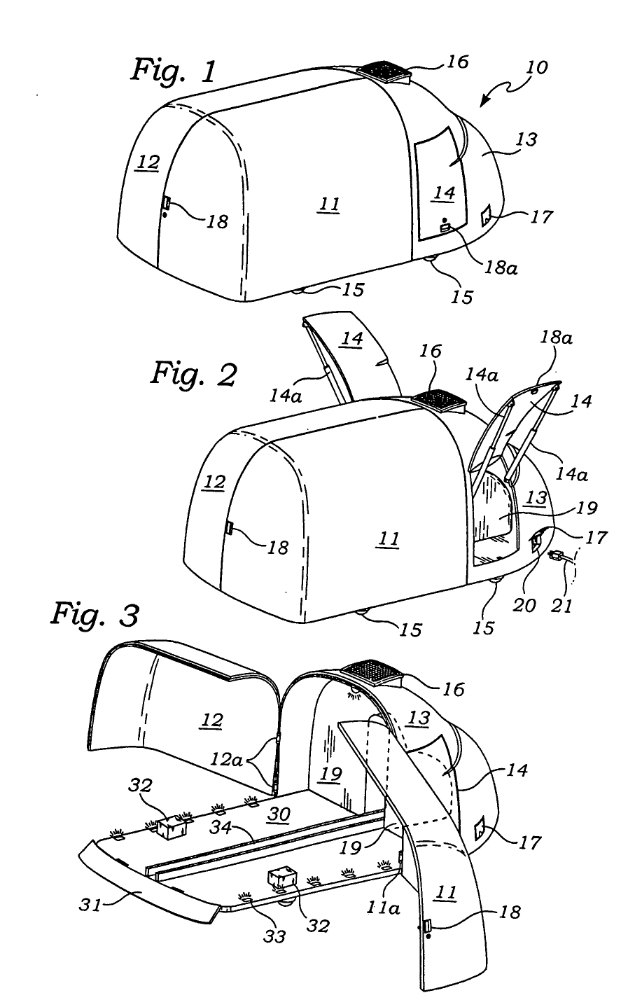

Referring now to the drawings there is shown an embodiment of the storage enclosure of the invention which generally illustrates a portable protective enclosure for small personal vehicles such as motorcycles. However, it will be understood that the invention may also be used, with proper modifications, for the storage of all-terrain vehicles, motorbikes, snow mobiles, personal watercraft or other such small vehicles. FIG. 1 illustrates in perspective view the assembled storage enclosure, generally designated by reference numeral 10, in the closed position. Shown are the right and left rear combination roofing/rear members of the enclosure, designated 11 and 12, respectively, the frontal cab-like member 13 having access doors or covers 14 (one shown), casters 15 (two of four shown), solar panel 16, and electrical receptacle cover plate 17. Solar panel 16 includes appropriate conventional electrical means (not shown) for providing power capability for interior lighting or other electrical devices as desired. Solar panel 16 may be mounted as indicated in the drawings, mounted at other selected locations, or designed for separate attachment as may be desired, Various enclosure locking means such as 18, 18a are included as necessary, although but not all shown in the drawings. Mutually engaging attachment devices (not shown) are provided for releasably joining the individual panel members into an integrated assembled structure as shown in FIG. 1. For proper sealing engagement of the panel members, each mating edge or surface of a panel member includes suitable sealing means which can include attachment grooves, such as tongue and groove, as well as a vinyl or rubber-like coating on the mating edges or surfaces of the panels.

FIG. 2 is a perspective view of the assembled enclosure of FIG. 1 illustrating substantially identical access doors 14 in the open position for accessing utility compartments 19 (one shown) on each side of the enclosure 10. Doors 14 are fitted with supports 14a which may be of pneumatic or other suitable design. Also indicated is electrical receptacle 20 and power source plug 21. Electrical power receptacle means 20 may include associated electrical converter means (not shown) for providing electricity for interior lighting, battery charging, the mobility control mechanism (as will be further discussed infra), or other electrical devices as desired. For instance, although not shown, the enclosure 10 may include appropriately located exhaust means for venting the interior of the enclosure 10. The exhaust means may typically include fans powered by electrical means 20 for exhausting air through selectively located and sheltered apertures in enclosure 10.

Although the structural members of the enclosure 10 may be formed of any suitable material in any suitable manner, these members, including the rear roofing members 11 and 12, the frontal cab-like member 13 and the access covers 14 and 17 are typically formed of molded plastic.

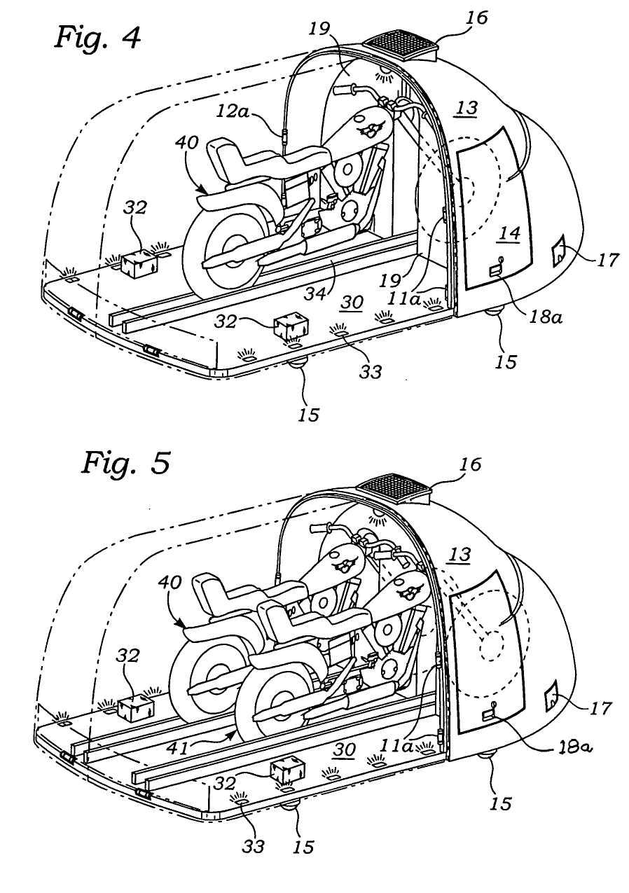

FIG. 3 is a perspective view of the assembled enclosure of FIG. 1 illustrating both the right roofing/rear member 11 and the substantially identical left roofing/rear member 12 in the open position to thereby illustrate the interior of the enclosure 10. Both roofing/rear members 11, 12 swing open on hinges 11a and 12a, respectively, that are mounted onto the cab-like front member 13. As seen the roofing/rear members 11, 12 swing outwardly from substantially planar base 30 and forwardly on hinges 11a and 12a. As more clearly seen in this figure, except for cab-like member 13, roofing/rear members 11 and 12 are complementary with each providing one-half of the roof, a side, and one-half of the rear of the enclosure 10. Also shown is vehicle loading ramp 31 (shown lowered), mobility control mechanism housings 32 (two of four shown), utility compartments 19, and a plurality of interior base mounted lights 33 (for simplicity indicated only at one location). It is to be understood that additional interior lighting can be installed as may be desired. A pair of longitudinally extending rails 34 is mounted vertically on the surface of the base 30 to provide a stabilization trough for the wheels of a motorcycle (see FIG. 4). When raised or detached ramp 31 fits inside of the enclosure as indicated in FIG. 4.

FIG. 4 is a perspective view of the enclosure of FIG. 1, with roofing/rear members 11 and 12 removed, illustrating the manner of placement of a motorcycle, generally designated 40, within the rails 34. Although not shown, straps or other appropriate tie-downs are included to provide stable and secure placement of the vehicle within rails 34. Further, although rails 34 are shown to form a stabilization trough, it is understood that other wheel well means, such as troughs molded or otherwise formed in base 30 could be used. Even though motorcycle 40 is illustrated, it is understood that other small personal vehicles such as all-terrain vehicles, personal watercraft, and snow mobiles. For proper stable and secure placement of other vehicles the stabilization the trough and tie-down means would be modified as necessary.

FIG. 5 is a perspective view of the enclosure of FIG. 1, with roofing/rear members 11 and 12 removed, illustrating the manner of placement of two motorcycles 40, 41 within the enclosure 10. An additional set of rails 34 provide a stabilization stand support for accepting the motorcycle 41. In this embodiment compartments 19 are modified as needed to accept the second motorcycle 41. Associated tie-downs can be modified as necessary to provide proper positioning and stabilization of the motorcycles 40, 41.

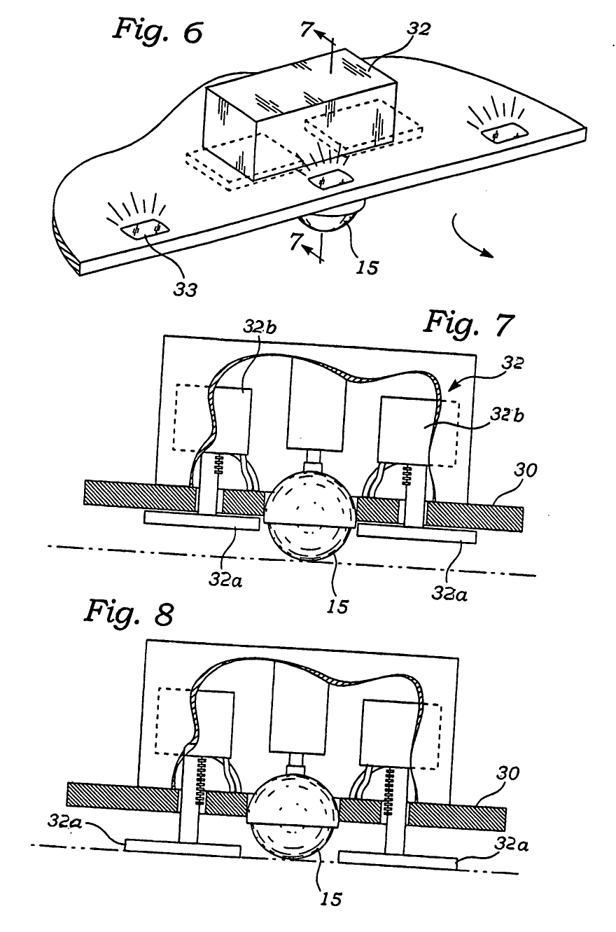

FIG. 6 is a cut-away perspective view of the enclosure 10 illustrating in greater detail the location and configuration of right rear mobility mechanism housing 32. Although four such housings with associated mobility mechanisms are indicated, one for each caster, it is to be understood that other modifications could be designed within the scope of the invention wherein fewer or more combinations of casters and/or mobility mechanism are used. Also shown in greater detail are typical base mounted lights 33.

FIG. 7 is a cut-away cross-sectional view taken generally along line 7-7 of FIG. 6 illustrating the typical mobility control mechanism 32 of the invention with the two associated friction pads 32a in the raised position for mobility of the enclosure 10. Mobility control mechanism 32 may consist of electrical motor 32b operating a conventional gear mechanism switched to raise or lower the associated friction pads 32a. As seen, friction pads 32a are in the raised position and the casters 15 are free to move to provide desired mobility of the enclosure 30. Although nor shown, the mobility control mechanism 32 may alternatively consist of an appropriate either a manual or hydraulic system.

FIG. 8 illustrates the mobility control mechanism 32 of FIG. 8 with the pads 32a in the lowered position for stable stationary positioning of the enclosure. In this mode, the pads 32a are in the lowered position whereby as shown they may raise the enclosure 10 so that the casters 15 are not in contact with the ground or may function to provide sufficient friction to restrain movement of the casters 15. The mobility mechanisms 32 may be individually operated as may be desired It is to be understood that within the scope of the invention other means, such as hydraulic, may be used to provide mobility control of the casters 15 to effect mobility of the enclosure 10.

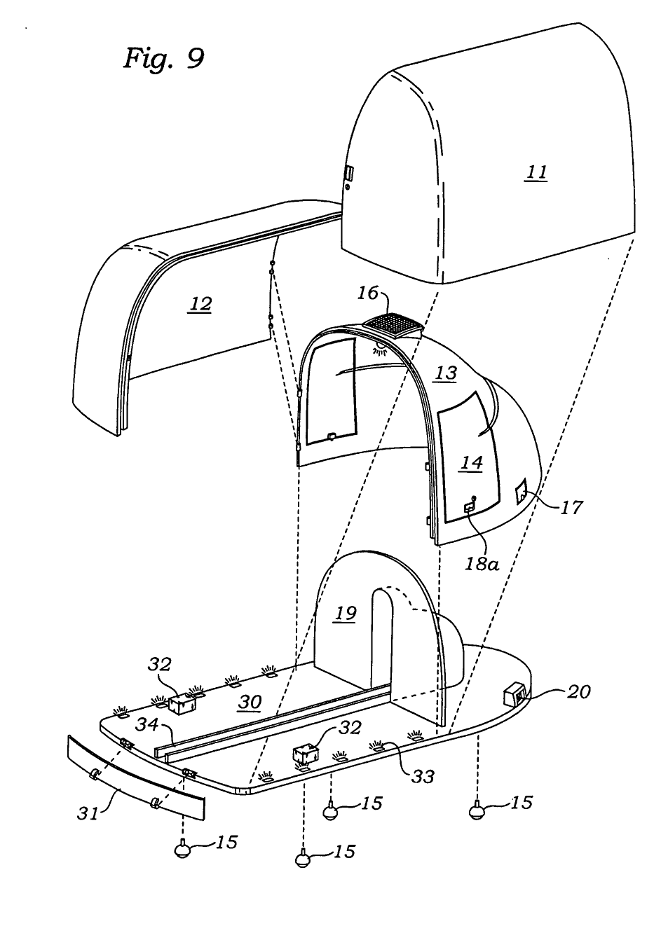

FIG. 9 illustrates, in a perspective exploded view, the enclosure 10 in accordance with the configuration of the invention as shown in FIG. 4. As shown and described the invention lends itself to being easily produced using conventional manufacturing processes and using readily available materials such as polypropylene, ABS, or high-density polyethylene. It may be provided in a variety of sizes and colors and available in either kit form ready for assembly or it may be provided already assembled. The enclosure and contents may be stored in a residence garage or if placed outside the enclosure would shield the contents from the elements. There has thus been shown and described a durable all-weather enclosure for motorcycles and other small personal vehicles. Although an embodiment of the enclosure has been shown and described, other embodiments can be devised by those skilled in the art that that would fall within the scope of the invention. Accordingly, the scope of the invention should not be construed as limited to the specific embodiments depicted and described.

What is claimed is:

1. A protective enclosure for small vehicles comprising:
enclosure means having a generally clam shell like configuration and including a generally planar base, right and left complementary and substantially identical rear side and roof portions mating to encompass a rear area of said base,
a cab-like front portion mating with said rear side and roof portions and encompassing the remainder of said base;
releasable attachment means for engagement of said base, rear roof portions and front portion to provide an integrated assembled enclosure; and
means for mounting and securing a selected vehicle within said enclosure.

2. The enclosure of claim 1 wherein said right and left rear roof portions are releasable from each other and from said base to swing open outwardly from said base and forwardly toward said front portion on respective hinges mounted to said front portion.

3. The enclosure of claim 1 further including caster means providing for mobility of said enclosure.

4. The enclosure of claim 1 further including retractable friction pads providing for stable stationary positioning of said enclosure.

5. The enclosure of claim 1 further including mobility control means operable to provide rolling mobility to said enclosure or alternatively provide for stationary friction positioning of said enclosure.

6. The enclosure of claim 1 further including mobility control means comprised of caster means for mobility and deployable friction means for negating said caster means to provide traction for stationary positioning.

7. The mobility control means of claim 6 wherein said friction means are deployed by electrical means.

8. The mobility control means of claim 6 wherein said friction means are deployed by hydraulic means.

9. A protective enclosure for small vehicles comprising:
enclosure means including a generally planar base, right and left complementary and substantially identical rear side and roof portions mating to encompass a rear area of said base,
a front portion mating with said rear side and roof portions and encompassing the remainder of said base;
releasable attachment means for engagement of said base, rear roof portions and front portion to provide an integrated assembled enclosure;
means for mounting and securing a vehicle within said enclosure; and
mobility control means operable to alternatively provide mobility to said enclosure or to provide stationary friction positioning of said enclosure.

10. The enclosure of claim 9 wherein said friction means are deployed by means taken from the group of manual, electrical and hydraulic.
